(19) United States
(12) Patent Application Publication
(10) Pub. No.: US 2026/0278945 A1
(43) Pub. Date: Sep. 17, 2026

(54) INFORMATION PROCESSING SYSTEM, INFORMATION PROCESSING APPARATUS, AND INFORMATION PROCESSING METHOD

(71) Applicants: Takumi KOIKE, Kanagawa (JP); Yuuto GOTOH, Kanagawa (JP); Masaki NOSE, Kanagawa (JP)

(72) Inventors: Takumi KOIKE, Kanagawa (JP); Yuuto GOTOH, Kanagawa (JP); Masaki NOSE, Kanagawa (JP)

(21) Appl. No.: 19/562,942

(22) Filed: Mar. 11, 2026

(30) Foreign Application Priority Data
Mar. 14, 2025 (JP) 2025-041336
Jan. 27, 2026 (JP) 2026-011294

(51) Int. Cl. G06T 19/00; H04N 7/15; H04N 21/81

(52) U.S. Cl. CPC G06T 19/00; H04N 7/157; H04N 21/816; G06T 2219/024

(57) ABSTRACT

An information processing system includes circuitry to generate video data of a virtual space in which a plurality of users participate, based on a video distribution session corresponding to the virtual space, and distribute voice data used for voice interaction, among a plurality of terminals used by the plurality of users participating in the virtual space, the video data being associated with the video distribution session, wherein the circuitry is to receive, from a first terminal of the plurality of terminals used by a first user of the plurality of users participating in the virtual space, voice data relating to speech of the first user, and distribute the received voice data to a second terminal of the plurality of terminals used by a second user of the plurality of users participating in the virtual space, using the video distribution session.

### CROSS-REFERENCE TO RELATED APPLICATIONS

This patent application is based on and claims priority pursuant to 35 U.S.C. § 119(a) to Japanese Patent Application Nos. 2025-041336, filed on Mar. 14, 2025, and 2026-011294, filed on Jan. 27, 2026, in the Japan Patent Office, the entire disclosure of which is hereby incorporated by reference herein.

### BACKGROUND

### Technical Field

The present disclosure relates to an information processing system, an information processing apparatus, and an information processing method.

### Related Art

Metaverse technology is known as a virtual space in which each user employs an avatar, which is a character representing the user himself/herself, to interact online with other users, and is utilized in, for example, games.

Rendering processing of images of virtual spaces such as the metaverse requires advanced graphics processing units (GPUs) or specialized hardware. When the rendering processing is performed on a terminal side, the user is required to prepare an expensive terminal.

On the other hand, mechanisms (which may be referred to as “image distribution mechanisms” in the following description) which stream rendered image frames to a browser via web real time communication (WebRTC), such as Pixel Streaming provided by Unreal Engine of Epic Games, have been proposed. By applying the image distribution mechanism to virtual spaces such as the metaverse, a user can utilize such virtual spaces as long as the user has a terminal equipped with a browser.

### SUMMARY

The present disclosure described herein provides an information processing system including circuitry to generate video data of a virtual space in which a plurality of users participate, based on a video distribution session corresponding to the virtual space, and distribute voice data used for voice interaction, among a plurality of terminals used by the plurality of users participating in the virtual space, the video data being associated with the video distribution session. The circuitry is to receive, from a first terminal of the plurality of terminals used by a first user of the plurality of users participating in the virtual space, voice data relating to speech of the first user, and distribute the received voice data to a second terminal of the plurality of terminals used by a second user of the plurality of users participating in the virtual space, using the video distribution session.

The present disclosure described herein provides an information processing apparatus including circuitry to generate video data of a virtual space in which a plurality of users participate, based on a video distribution session corresponding to the virtual space, and distribute voice data used for voice interaction, among a plurality of terminals used by the plurality of users participating in the virtual space, the video data being associated with the video distribution session. The circuitry is to receive, from a first terminal of the plurality of terminals used by a first user of the plurality of users participating in the virtual space, voice data relating to speech of the first user, and distribute the received voice data to a second terminal of the plurality of terminals used by a second user of the plurality of users participating in the virtual space, using the video distribution session.

The present disclosure described herein provides an information processing method including generating video data of a virtual space in which a plurality of users participate, based on a video distribution session corresponding to the virtual space, and distributing voice data used for voice interaction, among a plurality of terminals used by the plurality of users participating in the virtual space, the video data being associated with the video distribution session. The distributing includes receiving, from a first terminal of the plurality of terminals used by a first user of the plurality of users participating in the virtual space, voice data relating to speech of the first user, and distributing the received voice data to a second terminal of the plurality of terminals used by a second user of the plurality of users participating in the virtual space, using the video distribution session.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system;

FIG. 2 is a diagram illustrating a hardware configuration of a distribution server;

FIG. 3 is a diagram illustrating a functional configuration of an information processing system;

FIG. 4 is a flowchart of a process related to voice interaction between users; and

FIG. 5 is a flowchart of a process related to voice interaction between a user and an AI agent.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

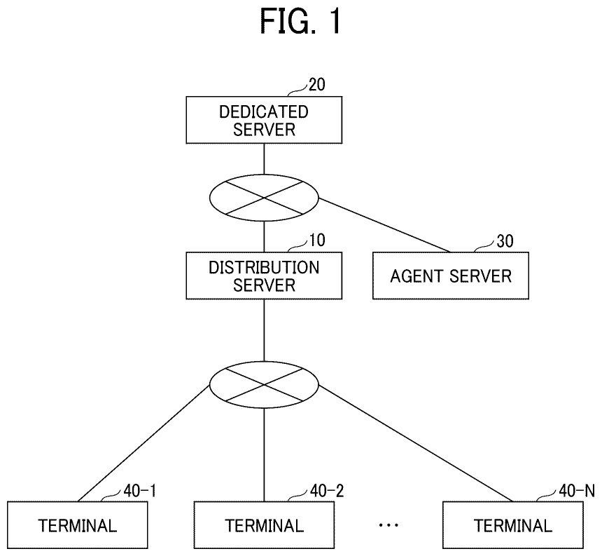

Referring now to the drawings, embodiments of the present disclosure are described below. FIG. 1 is a diagram illustrating a configuration of an information processing system. In FIG. 1, a distribution server 10 and an agent server 30 are connected to a dedicated server 20 via a network such as a local area network (LAN) or the Internet. A plurality of terminals 40-1 to 40-N are connected to the distribution server 10 via the network such as the Internet.

The dedicated server 20 includes one or more computers on which a game server program for implementing a virtual space such as a metaverse is executed, and, under control of the game server program, manages information on the virtual space. The dedicated server 20 also has a function of relaying the voice of speech from each user in order to implement voice interaction (voice chat) in the virtual space between the users using the respective terminals 40-1 to 40-N.

The distribution server 10 is an example of an information processing apparatus. The distribution server 10 includes one or more computers that generate (render) images of the virtual space in which the users using the respective terminals 40-1 to 40-N participate, transmit the images to the respective terminals 40-1 to 40-N, and transmit (distribute) voice data relating to the virtual space, which is transmitted (distributed) from the dedicated server 20, to the respective terminals 40-1 to 40-N. The distribution server 10 receives, from each of the respective terminals 40-1 to 40-N, voice data resulting from speech made by each user and operation data indicating operations performed by each user on the virtual space, and transmits data received from the respective terminals 40-1 to 40-N (which may be referred to as “terminal data” in the following description) to the dedicated server 20.

The term virtual space refers to a digital space in which each user can interact with other users by using a character representing the user (which may be referred to as “avatar” in the following description). Accordingly, in the virtual space, each user acts through the avatar. An example of interaction in the virtual space is a game.

The agent server 30 includes one or more computers that function as a single virtual user participating in the virtual space (which may be referred to as “AI agent” in the following description). The AI agent responds to the speech made by the other users by using artificial intelligence (AI) such as a machine learning model.

Each of the terminals 40-1 to 40-N is a terminal used by each user participating in the virtual space, on which a web browser (which may be referred to simply as “browser” in the following description) operates. For example, each of the terminals 40-1 to 40-N may be implemented by a personal computer (PC), a smartphone, or a tablet PC. For example, each of the terminals 40-1 to 40-N includes a CPU, a memory, a communication circuit such as a network interface circuit, and a display.

The terminals 40-1 to 40-N each reproduce the video and audio of the virtual space using the browser. The terminals 40-1 to 40-N each transmit, to the distribution server 10, voice data of the user's speech input through the browser, and operation data indicating operations performed by the user on the virtual space (in other words, terminal data).

Communication between the distribution server 10 and the respective terminals 40-1 to 40-N is performed through a video distribution session established for each virtual space. The video distribution session is managed in association with identification information for identifying the virtual space, and one or more of the terminals 40-1 to 40-N participating in the identified virtual space are connected through the same video distribution session.

The voice data of speech of a certain user, which has been transmitted from one of the terminals 40-1 to 40-N to the distribution server 10, is distributed to the other terminals of the terminals 40-1 to 40-N operated by the other users and to the agent server 30. The voice data of speech by the AI agent is also distributed to the respective terminals 40-1 to 40-N via the dedicated server 20 and the distribution server 10. By distributing the voice data of speech of the users of the other terminals of the terminals 40-1 to 40-N or of the AI agent to the terminal 40 of the terminals 40-1 to 40-N or the agent server 30, each user and the AI agent perform voice interaction (voice chat) in the metaverse space.

The dedicated server 20 and the agent server 30 may be implemented by a computer having the same hardware structure as the computer implementing the distribution server 10 as described below.

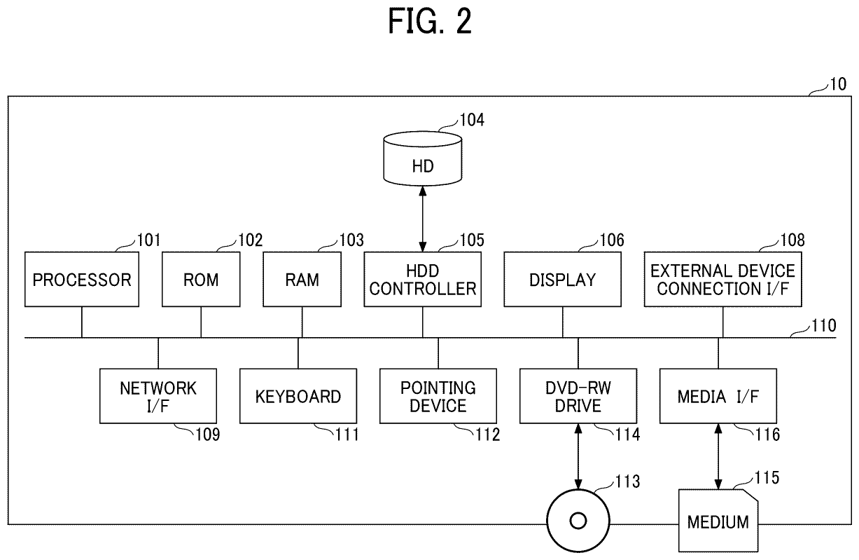

FIG. 2 is a diagram illustrating a hardware configuration of a distribution server 10. As illustrated in FIG. 2, the distribution server 10 is implemented by a computer, which includes a processor 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disk rewritable (DVD-RW) drive 114, and a media I/F 116.

The processor 101 is a CPU, a graphics processing unit (GPU), or both a CPU and a GPU, and controls the overall operation of the distribution server 10. The ROM 102 stores a program such as an initial program loader (IPL) to boot the processor 101. The RAM 103 is used as a work area for the processor 101. The HD 104 stores various data such as a program. The HDD controller 105 controls the reading of various data from, or the writing of various data to, the HD 104 under the control of the processor 101. The display 106 displays various types of information, such as a cursor, a menu, a window, text, or an image. The external device connection I/F 108, which may be implemented by an interface circuit, is an interface for connection with various external devices. Examples of the external devices in this case include, but are not limited to, a universal serial bus (USB) memory and a printer. The network I/F 109 is an interface circuit that controls the data communication with various external devices through a communication network. Examples of the data bus 110 include, but are not limited to, an address bus and a data bus, which electrically connect the components such as the processor 101 with one another.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The DVD-RW drive 114 reads and writes various data from and to a DVD-RW 113, which is an example of a removable storage medium. The removable recording medium is not limited to a DVD-RW and may be, for example, a digital versatile disc recordable (DVD-R). The media I/F 116 controls the reading of data from, or the writing (storing) of data to (in), a recording medium 115 such as a flash memory.

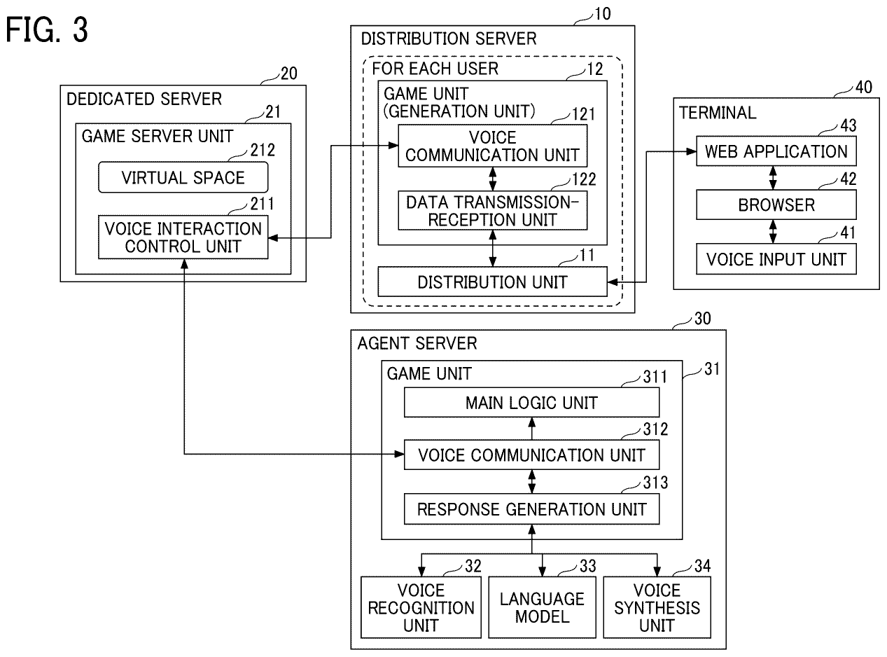

FIG. 3 is a diagram illustrating a functional configuration of the information processing system.

In FIG. 3, the dedicated server 20 includes a game server unit 21. The game server unit 21 is implemented by processing executed by the processor of the dedicated server 20 through a game server program installed on the dedicated server 20.

The game server unit 21 performs management of users and management of game units corresponding to the respective users, and also manages information relating to a virtual space 212 representing the metaverse. The dedicated server 20 further includes a voice interaction control unit 211 for performing voice interaction between the users and between the user and the AI agent.

The voice interaction control unit 211 receives, from the game unit 12 booted in the distribution server 10 for each user of each of the respective terminals 40-1 to 40-N, the voice of speeches of the user corresponding to the game unit 12, and transmits (distributes) the voice of a certain user to the game units 12 corresponding to the other users and to the game unit 31 of the agent server 30. In this manner, speeches made by a certain user are distributed to the other users and to the AI agent, thereby enabling the voice interaction between the users and between the user and the AI agent.

The dedicated server 20 may also execute the same processing as the processing when the dedicated server 20 is used for any desired game using the virtual space.

The distribution server 10 includes, for each user (in other words, for each of the respective terminals 40-1 to 40-N), the game unit 12 and the distribution unit 11. Each of the above-mentioned functional units is implemented by the processor 101 executing one or more programs installed on the distribution server 10. For example, the game unit 12 and the distribution unit 11 are booted by the processor 101 as processes of the program for each user.

The game unit 12 generates video data representing the virtual space based on the video distribution session, and transmits the generated video data to the respective terminals 40-1 to 40-N participating in the virtual space through the video distribution session. The game unit 12 connects to the game server unit 21 and executes a process for causing the avatar of the user corresponding to the game unit 12 to participate in the virtual space 212. The game unit 12 is also an example of a generation unit that generates (renders) video data representing the virtual space 212, and transmits the generated video data to the distribution unit 11 corresponding to the same user.

The game unit 12 also includes a voice communication unit 121 and a data transmission-reception unit 122. The voice communication unit 121 transmits the voice data in the virtual space 212 to the distribution unit 11 corresponding to the same user via the data transmission-reception unit 122 corresponding to the same user. The voice data in the virtual space 212 includes voice data distributed from the voice interaction control unit 211 of the dedicated server 20 to each game unit 12. The voice communication unit 121 further transmits, to the voice interaction control unit 211 of the dedicated server 20, the voice of speeches of the user included in terminal data received by the data transmission-reception unit 122 corresponding to the same user from the distribution unit 11 corresponding to the same user. The data transmission-reception unit 122 transmits video data generated by the game unit 12 and voice data from the voice communication unit 121 to the respective terminals 40-1 to 40-N, and receives terminal data from the respective terminals 40-1 to 40-N.

The distribution unit 11 performs transmission and reception of voice data used for voice interaction with the respective terminals 40-1 to 40-N of users participating in the virtual space, by using the same session as a video distribution session. In other words, the distribution of video data and the distribution of voice data are managed in association with the same session.

The distribution unit 11 transmits (streams) video data generated by the game unit 12 and voice data (such as voice data of speeches of other users) from the voice communication unit 121 to the respective terminals 40-1 to 40-N corresponding to the distribution unit 11. The distribution unit 11 also receives terminal data from the respective terminals 40-1 to 40-N and transmits the terminal data to the game unit 12. For example, a Pixel Streaming mechanism can be used for transmission (distribution) of video data and voice data from the distribution unit 11 and transmission of terminal data from the respective terminals 40-1 to 40-N to the distribution unit 11. Other mechanisms may be used.

Each of the respective terminals 40-1 to 40-N includes a voice input unit 41, a browser 42, and a web application 43. These units are implemented by the CPU of the respective terminals 40-1 to 40-N that execute processes according to the program installed on the respective terminals 40-1 to 40-N.

The voice input unit 41 inputs voice (voice of user's speech) from a microphone included in each of the respective terminals 40-1 to 40-N, and inputs voice data based on the input voice to the browser 42.

The browser 42 is a general web browser.

The web application 43 is an application including display data and programs (scripts), which is downloaded from the distribution server 10 when the browser 42 accesses the distribution server 10. The web application 43 has a function (a function as a client for the distribution unit 11) that is paired with the distribution unit 11, and causes the browser 42 to reproduce video data (in other words, video data representing the virtual space) and voice data transmitted from the distribution unit 11. The web application 43 also transmits, to the distribution unit 11, terminal data such as voice data of a user's speech and operation data based on an operation on the browser 42, which are input from the voice input unit 41 to the browser 42.

The agent server 30 includes a game unit 31, a voice recognition unit 32, a language model 33, and a voice synthesis unit 34. These units are implemented by processing executed by the processor of the agent server 30 through one or more programs installed in the agent server 30.

The game unit 31 connects to the game server unit 21 and executes processing for causing the avatar of the AI agent to participate in the virtual space 212. The game unit 31 includes a main logic unit 311, a voice communication unit 312, and a response generation unit 313. The main logic unit 311 connects to the game server unit 21 and executes processing for enabling access to the virtual space 212. The voice communication unit 312 receives voice data (voice data of speeches of the user) transmitted from the voice interaction control unit 211, and transmits the voice data to the response generation unit 313. The voice communication unit 312 further transmits, to the voice interaction control unit 211, voice data indicating a response generated by the response generation unit 313 to the voice represented by the voice data.

The voice recognition unit 32 generates text indicating the speech content of the voice data by applying voice recognition to the voice data received by the response generation unit 313 from the voice communication unit 312.

The language model 33 generates text indicating a response to the text (which may be referred to as “response text” in the following description). The language model 33 is a machine learning model trained to generate, with a text as input, a text that contains an appropriate response to the text. For example, a large language model (LLM) can be used as the language model 33.

The voice synthesis unit 34 generates voice data indicating the response text generated by the language model 33 by using a voice synthesis technique.

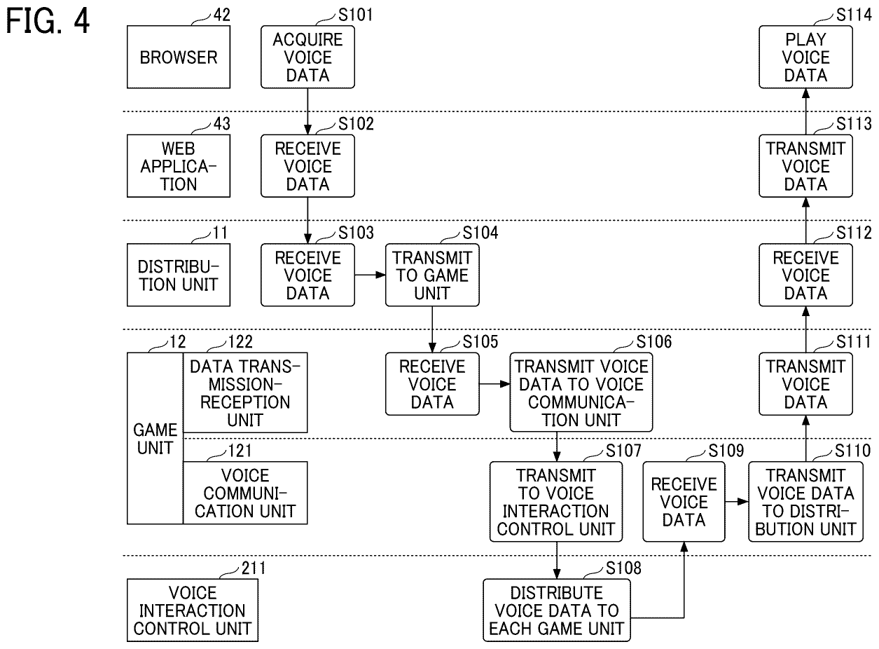

The processes performed by the information processing system will be described below. FIG. 4 is a flowchart of a process related to voice interaction between users. In FIG. 4, it is assumed that users of the respective terminals 40-1 to 40-N are participating in the same virtual space 212. Accordingly, in the respective terminals 40-1 to 40-N, video data and voice data of the virtual space 212 are being distributed from the distribution unit 11 corresponding to the respective terminals 40-1 to 40-N.

When a user (which may be referred to as “user x” in the following description) of one of the terminals 40-1 to 40-N (hereinafter referred to as “device 40-x”) speaks, the voice input unit 41 of the device 40-x inputs the voice data of the speech to the browser 42 (hereinafter referred to as “browser 42x”) of the device 40-x. As a result, in step S101, the browser 42x acquires the voice data. The user x is an example of a first user.

In step S102, the web application 43 on the browser 42x transmits the voice data to the distribution unit 11 corresponding to the user x (terminal 40-x) (the distribution unit 11 may be referred to as “distribution unit 11x” in the following description). In step S103, the distribution unit 11x receives the voice data. In step S104, the distribution unit 11x transmits the voice data to the game unit 12 corresponding to the user x (terminal 40-x) (the game unit 12 may be referred to as “game unit 12x” in the following description).

In step S105, the data transmission-reception unit 122 of the game unit 12x receives the voice data. In step S106, the data transmission-reception unit 122 transmits the voice data to the voice communication unit 121 of the game unit 12x. At this time, the data transmission-reception unit 122 stores the packet of the audio signal, for example, in a buffer managed by the voice communication unit 121. The voice communication unit 121 acquires the voice data from the buffer when a sufficient number of packets are stored in the buffer. As a result, the transmission of the voice data from the data transmission-reception unit 122 to the voice communication unit 121 is efficiently performed.

In step S107, the voice communication unit 121 of the game unit 12x transmits the voice data to the voice interaction control unit 211 of the game server unit 21. In step S108, the voice interaction control unit 211 distributes (transmits) the voice data to the voice communication unit 121 of each game unit 12 corresponding to a user (an example of a second user) different from the user x. In step S109, the voice communication unit 121 of each game unit 12 receives the voice data. In step S110, the voice communication unit 121 transmits the voice data to the data transmission-reception unit 122 belonging to the same game unit 12. In step S111, the data transmission-reception unit 122 of each game unit 12 transmits the voice data to the distribution unit 11 corresponding to the same respective terminals 40-1 to 40-N as the game unit 12, as voice data in the virtual space 212. In step S112, each of the distribution units 11 transmits (for example, streaming distribution) the voice data to the respective terminals 40-1 to 40-N corresponding to the distribution units 11 as voice data in the virtual spaces 212.

In step S113, the web application 43 of each of the respective terminals 40-1 to 40-N receives the voice data. In step S114, the Web application 43 causes the browser 42 to execute the reproduction of the voice data. As a result, users other than the user x can also hear the speech of the user x. In response to this speech, another user speaks a response, and the processing procedure illustrated in FIG. 4 is executed accordingly, whereby a voice interaction (voice chat) between users can be realized.

Pixel Streaming has been primarily responsible for video distribution, however, the voice data from the respective terminals 40-1 to 40-N is transferred from the distribution unit 11 to the voice communication unit 121, and the voice data is delivered, via the voice interaction control unit 211, to the voice communication unit 121 corresponding to each user, thereby enabling voice interaction within the virtual space 212 (in other words, in-game). Thus, since both video distribution and voice interaction are provided via the same video distribution session, the user is not required to perform separate communication settings for voice interaction when participating in the virtual space.

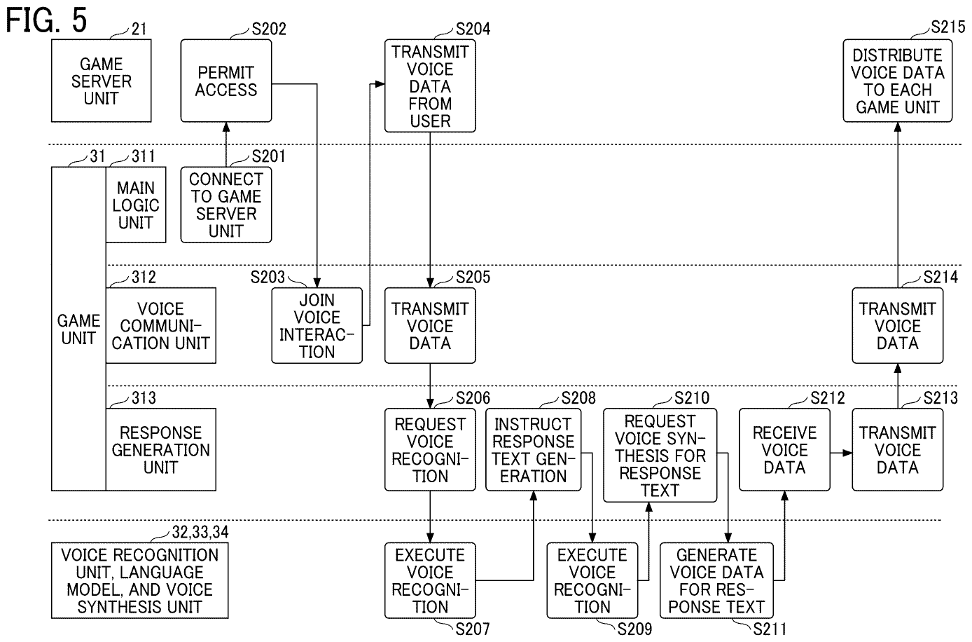

A description will now be given below regarding voice interaction between the user and an AI agent. FIG. 5 is a flowchart of a process related to voice interaction between a user and an AI agent.

In step S201, the main logic unit 311 of the game unit 31 connects to the game server unit 21 so that, for example, the voice communication unit 312 of the game unit 31 may access the game server unit 21. In step S202, the game server unit 21 permits access. In step S203, the voice communication unit 312 of the game unit 31 requests the voice interaction control unit 211 to participate in the voice interaction. As a result, the voice interaction control unit 211 distributes the voice data to the voice communication unit 312.

In step S204, when the voice interaction control unit 211 receives voice data (voice data of the user's speech) from the voice communication unit 121 of the game unit 12 corresponding to any of the users, the voice communication unit 121 transmits the voice data to the voice communication unit 312. It should be noted that step S204 is executed in association with step S108 illustrated in FIG. 4. In other words, when the voice interaction control unit 211 distributes the voice data to each game unit 12 in step S108 illustrated in FIG. 4, the voice interaction control unit 211 also transmits the voice data to the game unit 31.

In step S205, when the voice communication unit 312 of the game unit 31 receives the voice data, the voice communication unit 312 transmits the voice data to the response generation unit 313. At this time, the voice communication unit 312 sequentially stores the packets of the voice data in the buffer, and transmits the voice data related to the group of the packets to the response generation unit 313 at the time when a sufficient packet group is stored in the buffer. This enables efficient processing of the voice data.

In step S206, the response generation unit 313 transmits the voice data to the voice recognition unit 32, thereby requesting the voice recognition unit 32 to perform voice recognition on the voice data. In step S207, the voice recognition unit 32 applies the voice recognition to the voice data to generate a text indicating the speech content of the voice data, and transmits the text to the response generation unit 313. In step S208, the response generation unit 313 transmits a prompt for instructing the generation of a response sentence to the text to the language model 33. In step S209, when the prompt is input to the language model 33, the language model 33 generates the response sentence based on the prompt and the learned parameters, and transmits the response sentence to the response generation unit 313. In step S210, the response generation unit 313 requests the voice synthesis unit 34 to provide voice synthesis about the response sentence by transmitting the response sentence to the voice synthesis unit 34. In step S211, the voice synthesis unit 34 generates the voice data having the response sentence as the content of the speech by using the voice synthesis technology, and transmits the voice data to the response generation unit 313. The voice data indicates a response from the AI agent to the speech by the user.

In step S212, the response generation unit 313 receives the voice data. In step S213, the response generation unit 313 transmits the voice data to the voice communication unit 312. In step S214, the voice communication unit 312 transmits the voice data to the voice interaction control unit 211. In step S215, the voice interaction control unit 211, similarly to step S108 illustrated in FIG. 4, distributes (transmits) the voice data to the voice communication unit 121 of each game unit 12. Subsequently, steps S109 to S114 illustrated in FIG. 4 are executed. As a result, each user can hear the response from the AI agent. Thus, interaction between each user and the AI agent is realized.

As described above, in the distribution server 10 corresponding to the server side or the cloud side, rendering of the video data of the virtual space 212 is performed, and the result is distributed to the respective terminals 40-1 to 40-N in a streaming format. Accordingly, the respective terminals 40-1 to 40-N do not need to have a high-performance GPU or dedicated hardware. Since the hardware requirements are lowered, the user can readily experience the virtual space 212 by using the browser 42. In such a state, since the voice dialogue mechanism is integrated into the image distribution mechanism (such as the game unit 12 and the distribution unit 11), and the speech voice of each user is shared among the respective game units 12 by the voice interaction control unit 211, it is possible to reduce the necessity for the user of the respective terminals 40-1 to 40-N to perform installation, configuration, or other operations of special software for conducting voice dialogue in the virtual space 212. For example, even when a single user engages in voice interaction with the AI agent, it is possible to eliminate the inconvenience in which other users were unable to hear the content of such voice interaction. Accordingly, it is possible to simplify the construction of an environment for conducting voice dialogue in the virtual space. As a result, it is possible to enhance the ease of use and accessibility in the utilization of virtual spaces such as the metaverse, and expansion to a wide variety of user groups can be expected.

Further, enabling interaction with the AI agent makes it possible to realize sustained interaction. In conventional virtual spaces such as the metaverse, when administrators or other users are not present, the space tends to become desolate, and there is a possibility that interaction and liveliness will be lacking. Even when the users or the administrators are absent, it becomes possible to provide an interaction experience within the virtual space 212. As a result, it is possible to maintain the virtual space 212 as a “lively space” and to construct an environment in which it is continuously utilized. As a result, it is possible to expect an enhancement in utilization rate and engagement.

Further, it is possible to enable the construction of a new virtual space through technological integration. The Pixel Streaming technology, voice interaction (voice chat), and AI agent technology have each operated independently, and cooperation including voice data has been difficult. By integrating these technologies and constructing an entire system including a voice data pipeline, it is possible to provide an environment in which a user can easily experience virtual spaces such as the metaverse via a browser and enjoy natural interaction with the AI agent within the virtual space. For example, by combining high-quality rendering on the browser with natural dialogue with the AI agent, it is possible to provide the user with an immersive and smooth experience, and qualitative improvement can be expected.

From the above, by providing a new mechanism through outsourcing processing to the server side, utilizing AI agents, and integrating these technologies, it is possible to overcome the problems inherent in conventional technologies, dramatically enhance the accessibility, sustainability, and quality of experience of the metaverse, and provide new value to both users and administrators.

The distribution server 10, the dedicated server 20, and the agent server 30 are not limited to server computers, as long as they are devices equipped with communication functions. The distribution server 10, the dedicated server 20, and the agent server 30 may be, for example, an output device such as a projector (PJ), an interactive whiteboard (IWB; an electronic whiteboard having a blackboard function enabling mutual communication), or digital signage, or may be a heads-up display (HUD), an industrial machine, an imaging device, a sound recording device, a medical device, a networked home appliance, an automobile (connected car), a laptop personal computer (PC), a mobile phone, a smartphone, a tablet PC, a game console, a personal digital assistant (PDA), a digital camera, a wearable PC, or a desktop PC.

Each of the functions of the above-described embodiments can be implemented by one or more processing circuits or circuitry. In this specification, the “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit modules designed to perform the recited functions.

The illustrated apparatuses or devices are only illustrative of one of several computing environments for implementing one or more of the embodiments disclosed herein.

In some embodiments, the distribution server 10, the dedicated server 20, and the agent server 30 include multiple computing devices, such as a server cluster. The multiple computing devices are configured to communicate with each other through any type of communication links, including a network or a shared memory, to perform the processes disclosed herein.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following non-limiting examples illustrate aspects of the present disclosure.

### ASPECT 1

An information processing system includes a generation unit that generates video data of a virtual space in which a plurality of users participate, based on a video distribution session corresponding to the virtual space, and a distribution unit that distributes voice data, used for voice interaction, among respective terminals used by a plurality of users participating in the virtual space, the video data being linked to the same session as the video distribution session, the distribution unit receives, from a terminal used by a first user participating in the virtual space, voice data relating to speech of the first user, and distributes the received voice data to a terminal used by a second user participating in the virtual space, using the same session as the video distribution session.

### ASPECT 2

In the information processing system according to Aspect 1, the distribution unit receives, from a terminal used by the first user, voice data relating to a speech of the first user, the voice data having been input by a browser that displays the video data on the terminal.

### ASPECT 3

In the information processing system according to Aspect 1 or 2, the generation unit and the distribution unit are provided for each of the users, the image forming apparatus includes a voice interaction control unit that receives, from the generation unit, voice data related to the speech of the first user received by the generation unit corresponding to the first user, and transmits the voice data to the generation unit corresponding to the second user, and the distribution unit corresponding to the second user transmits the voice data received by the generation unit corresponding to the second user to the terminal used by the second user.

### ASPECT 4

The information processing system according to any one of Aspects 1 to 3 includes a voice synthesis unit that generates voice data representing a response to speech content indicated by voice data received from the terminal by the distribution unit, and the distribution unit transmits the voice data generated by the voice synthesis unit, as voice data in the virtual space, to the terminal used by the user corresponding to the distribution unit.

### ASPECT 5

The information processing system according to Aspect 4 includes a voice recognition unit that generates text indicating speech content of the voice data by applying voice recognition to the voice data received from the terminal by the distribution unit, and the voice synthesis unit generates the voice data indicating the response based on the text.

### ASPECT 6

An information processing apparatus includes a generation unit that generates video data of a virtual space in which a plurality of users participate, based on a video distribution session corresponding to the virtual space, and a distribution unit that distributes voice data, used for voice interaction, among respective terminals used by a plurality of users participating in the virtual space, the video data being linked to the same session as the video distribution session, the distribution unit receives, from a terminal used by a first user participating in the virtual space, voice data relating to speech of the first user, and distributes the received voice data to a terminal used by a second user participating in the virtual space, using the same session as the video distribution session.

### ASPECT 7

An information processing method includes generating video data of a virtual space in which a plurality of users participate, based on a video distribution session corresponding to the virtual space, and distributing voice data, used for voice interaction, among respective terminals used by a plurality of users participating in the virtual space, the video data being linked to the same session as the video distribution session, the distributing includes receiving, from a terminal used by a first user participating in the virtual space, voice data relating to speech of the first user, and distributing the received voice data to a terminal used by a second user participating in the virtual space, using the same session as the video distribution session.

### ASPECT 8

An information processing method includes generating video data of a virtual space in which a plurality of users participate, based on a video distribution session corresponding to the virtual space, and distributing voice data, used for voice interaction, among respective terminals used by a plurality of users participating in the virtual space, the video data being linked to the same session as the video distribution session, the distributing includes receiving, from a terminal used by a first user participating in the virtual space, voice data relating to speech of the first user, and distributing the received voice data to a terminal used by a second user participating in the virtual space, using the same session as the video distribution session.

In the related art, it was not possible to distribute voice uttered by each user to other users participating in the same virtual space as that user. The video distribution session providing video streaming and the voice interaction session were separated, and the user was required to separately establish a voice interaction environment.

According to one aspect of the present disclosure, it is possible to simplify the construction of an environment for conducting voice interaction in a virtual space.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising circuitry configured to:
generate video data of a virtual space in which a plurality of users participate, based on a video distribution session corresponding to the virtual space; and
distribute voice data used for voice interaction, among a plurality of terminals used by the plurality of users participating in the virtual space, the video data being associated with the video distribution session,
wherein the circuitry is configured to
receive, from a first terminal of the plurality of terminals used by a first user of the plurality of users participating in the virtual space, voice data relating to speech of the first user, and
distribute the received voice data to a second terminal of the plurality of terminals used by a second user of the plurality of users participating in the virtual space, using the video distribution session.

2. The information processing system according to claim 1,
wherein the circuitry is configured to receive, from the first terminal used by the first user, voice data relating to the speech of the first user, the voice data having been input by a browser that displays a video based on the video data on the first terminal.

3. The information processing system according to claim 1,
wherein the circuitry includes first circuitry configured to generate the video data of the first user and distribute the voice data of the first user, and second circuitry configured to generate the video data of the second user and distribute the voice data of the second user,
wherein the second circuitry is configured to receive the voice data of the first user, and transmit the voice data that is received to the second terminal used by the second user.

4. The information processing system according to claim 1,
wherein the circuitry is further configured to generate voice data representing a response to speech content indicated by voice data received from the second terminal, and
transmit the voice data that is generated as voice data in the virtual space, to the first terminal used by the first user.

5. The information processing system according to claim 4,
wherein the circuitry is configured to generate text indicating the speech content of the voice data by applying voice recognition to the voice data received from the second terminal, and generate the voice data representing the response based on the text.

6. An information processing apparatus comprising circuitry configured to:
generate video data of a virtual space in which a plurality of users participate, based on a video distribution session corresponding to the virtual space; and
distribute voice data used for voice interaction, among a plurality of terminals used by the plurality of users participating in the virtual space, the video data being associated with the video distribution session, wherein the circuitry is configured to
receive, from a first terminal of the plurality of terminals used by a first user of the plurality of users participating in the virtual space, voice data relating to speech of the first user, and
distribute the received voice data to a second terminal of the plurality of terminals used by a second user of the plurality of users participating in the virtual space, using the video distribution session.

7. An information processing method comprising:
generating video data of a virtual space in which a plurality of users participate, based on a video distribution session corresponding to the virtual space; and
distributing voice data used for voice interaction, among a plurality of terminals used by the plurality of users participating in the virtual space, the video data being associated with the video distribution session,
wherein the distributing includes
receiving, from a first terminal of the plurality of terminals used by a first user of the plurality of users participating in the virtual space, voice data relating to speech of the first user, and
distributing the received voice data to a second terminal of the plurality of terminals used by a second user of the plurality of users participating in the virtual space, using the video distribution session.
